(19) United States
(12) Patent Application Publication
(10) Pub. No.: US 2024/0127481 A1
(43) Pub. Date: Apr. 18, 2024

(54) SENSOR POSITION CALIBRATION DEVICE AND SENSOR POSITION CALIBRATION METHOD

(71) Applicant: HITACHI, LTD., Tokyo (JP)

(72) Inventors: So SASATANI, Tokyo (JP); Tsuyoshi KITAMURA, Tokyo (JP); Takuma OSATO, Tokyo (JP); Haruki MATONO, Tokyo (JP)

(73) Assignee: HITACHI, LTD., Tokyo (JP)

(21) Appl. No.: 18/481,174

(22) Filed: Oct. 4, 2023

(30) Foreign Application Priority Data
Oct. 7, 2022 (JP) 2022-162807

(51) Int. Cl. G06T 7/80; G05D 1/02

(52) U.S. Cl. CPC G06T 7/80; G05D 1/0214; G05D 1/0223; G05D 1/0246; G06T 2207/30196; G06T 2207/30244; G06T 2207/30252

(57) ABSTRACT

A sensor position calibration device includes a moving object information acquisition unit that acquires a self-position measured by a reference moving object moving in a movement area; a moving object measurement unit that measures a position of the reference moving object based on observation information of a camera; a calibration unit that calibrates position information of the camera by using the self-position of the moving object and an estimated position calculated based on the measured position and the position information of the camera; a calibration error calculation unit that calculates an error between a second estimated position and the self-position; a reliability map generation unit that, based on the error, generates a reliability map indicating reliability of position measurement in the movement area using the camera; and a moving object control unit that controls movement of the moving object by using the reliability map.

### BACKGROUND OF THE INVENTION

### 1. Field of the Invention

The present invention relates to a sensor position calibration device and a sensor position calibration method for calibrating a position of a sensor including a camera.

### 2. Description of the Related Art

Recent years have witnessed an increase in automation, and expectations for automation, of machines and facilities for the purpose of eliminating manpower shortages and improving productivity in accordance with a diminishing labor force due to lower birth rates and aging populations. By controlling each moving object in an area with a mixture of moving objects including people and vehicles, and so forth, for example, in public places or private places where infrastructure cameras are installed, in addition to warehouses, factories (including indoors), farms, mines, attraction venues, and the like, it is possible to perform system control with which both safety and productivity are achieved.

In a case where a vehicle is to perform autonomous control, a method of installing a camera or an in-vehicle sensor such as LiDAR (Light Detection and Ranging or Laser Imaging Detection and Ranging) in the vehicle and measuring position information or the like of objects around the vehicle to control a vehicle speed or the like is common. However, a region constituting a blind spot from the vehicle cannot be measured using only an in-vehicle sensor. Therefore, by installing infrastructure sensors around the travel route and notifying the vehicle of measurement results, more advanced vehicle control becomes possible.

In order to utilize the measurement results of the infrastructure sensors in vehicle control, a control system needs to correctly grasp the positions and attitude (orientation) of the infrastructure sensors, and thus calibration (also referred to as sensor position calibration) is required. For example, in a method for calibrating a position of an infrastructure sensor device, which is disclosed in JP 2022-038880 A, sensor position calibration is executed by measuring a moving object including a device capable of acquiring position information on a control system such as a GNSS (Global Navigation Satellite System) by using infrastructure sensors.

### SUMMARY OF THE INVENTION

By utilizing the technology of JP 2022-038880 A, it is possible to collect, in a control area, moving object position measurement results from the infrastructure sensors and self-position information of the moving object on a corresponding control system and to execute highly accurate sensor position calibration of the infrastructure sensors. However, because the position information to be collected depends on the route, speed, and the like of the moving object, the operation of the vehicle will likely be inefficient due to low accuracy-based vehicle control in which deviation occurs in the position information collected in the control area and there is deviation (unevenness) in the accuracy of the position measurement.

The present invention was conceived in view of such a background, and an object thereof is to provide a sensor position calibration device and a sensor position calibration method that perform efficient vehicle control corresponding to the accuracy of sensor position calibration.

In order to solve the above problem, a sensor position calibration device according to the present invention includes: a moving object information acquisition unit that acquires a self-position measured by a moving object moving in a movement area; a moving object measurement unit that measures a position of the moving object based on observation information of a sensor; a calibration unit that calibrates position information of the sensor by using the self-position of the moving object and an estimated position, which is a position of the moving object in the movement area calculated based on a measured position and the position information of the sensor, the measured position being a position of the moving object measured; a calibration error calculation unit that calculates an error between a second estimated position and the self-position, the second estimated position being a position of the moving object in the movement area calculated based on the measured position and the calibrated position information of the sensor; a reliability map generation unit that, based on the error, generates a reliability map indicating reliability of position measurement in the movement area using the sensor; and a moving object control unit that controls movement of the moving object by using the reliability map.

According to the present invention, it is possible to provide a sensor position calibration device and a sensor position calibration method that perform efficient vehicle control according to the accuracy of sensor position calibration. Problems, configurations, advantageous effects, and the like other than those described above will be clarified by the descriptions of the embodiments hereinbelow.

### BRIEF DESCRIPTION OF THE DRAWINGS

FIG. 1 is a functional block diagram of a sensor position calibration device according to a first embodiment;

FIG. 2 is a data configuration diagram of a moving object information database according to the first embodiment;

FIG. 3 is a data configuration diagram of a measurement information database according to the first embodiment;

FIG. 4 is a diagram to illustrate local positions according to the first embodiment;

FIG. 5 is a flowchart of sensor position calibration processing according to the first embodiment;

FIG. 6 is a diagram to illustrate a relationship between a local position coordinate system and a global position coordinate system according to the first embodiment;

FIG. 7 is a flowchart of reliability map generation processing according to the first embodiment;

FIG. 8 is a diagram showing a movement area divided into zones according to the first embodiment;

FIG. 9 is a diagram showing a reliability map according to the first embodiment;

FIG. 10 is a graph showing correction coefficients corresponding to distances from a camera to a zone according to the first embodiment;

FIG. 11 is a graph showing correction coefficients corresponding to the orientation of the moving object with respect to the camera according to the first embodiment;

FIG. 12 is a graph showing correction coefficients corresponding to the speed of the moving object according to the first embodiment;

FIG. 13 is a graph showing correction coefficients corresponding to the sparseness/denseness of a moving object according to the first embodiment; and

FIG. 14 is a functional block diagram of a vehicle control device according to a second embodiment.

### DESCRIPTION OF THE PREFERRED EMBODIMENTS

### <<Overview of Sensor Position Calibration Device>>

Hereinafter, a sensor position calibration device in a mode (embodiment) for carrying out the present invention will be described. A sensor position calibration device calibrates the position and attitude of a sensor (camera) to minimize the error between an own position (self-position) measured by the moving object (reference moving object to be described below), and a position of the moving object measured using the sensor. The sensor position calibration device generates a reliability map in which the movement area of the moving object is divided into a plurality of zones, and which represents the degree of error smallness of each zone as reliability. The sensor position calibration device controls the moving object to move at a low speed, for example, in a zone of low reliability (large error), thereby enabling an error in position measurement by the sensor in the zone to be reduced such that the calibration accuracy can be increased. Note that the moving object (vehicle) is applied to all industries, from primary industries to tertiary industries, and so forth, and is also applied to other industries.

### <<Configuration of Sensor Position Calibration Device>>

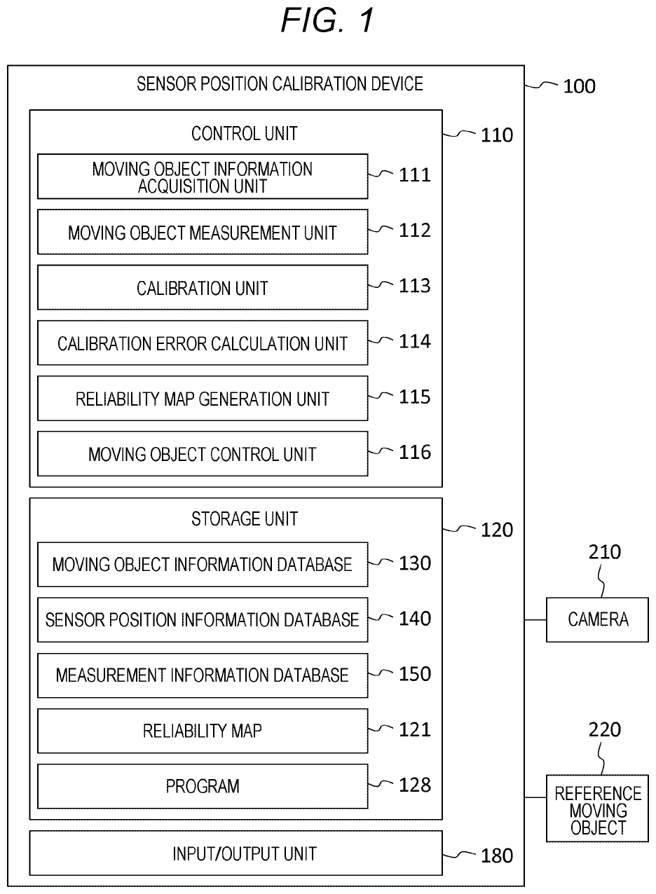

FIG. 1 is a functional block diagram of a sensor position calibration device 100 according to a first embodiment. The sensor position calibration device 100 is a computer, and includes a control unit 110, a storage unit 120, and an input/output unit 180. A camera 210 is connected to the sensor position calibration device 100. The camera 210 is not limited to a camera that captures images, and may be any sensor capable of measuring the position of an object in a movement area, such as a stereo camera or a distance measurement sensor. It is assumed that the field of view of the camera 210 substantially includes a movement area.

A reference moving object 220 is a moving object that moves in the movement area and that is capable of measuring an own position, orientation, and movement speed highly accurately. The reference moving object 220 may measure an own position, orientation, and movement speed by using a GNSS, for example, or may perform measurement by using SLAM (Simultaneous Localization and Mapping) technology. The reference moving object 220 transmits a measured own position, orientation, and movement speed to the sensor position calibration device 100 at predetermined timing, for example, periodically. Note that a moving object other than the reference moving object 220 is present in the movement area. A moving object that moves in the movement area and that transmits an own position, orientation, and speed to the sensor position calibration device 100 is defined as the reference moving object 220.

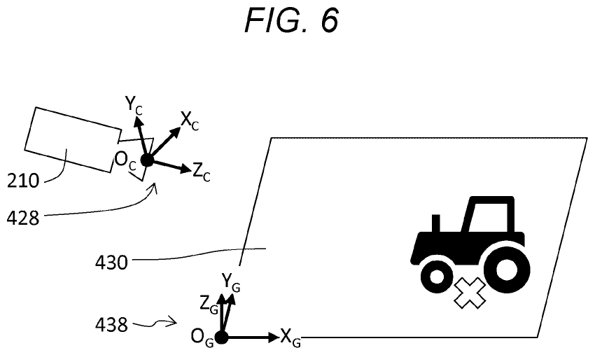

The reference moving object 220 is assumed to be a vehicle that conveys cargo such as a factory or a warehouse vehicle, but may be a person holding a terminal including a GNSS, an acceleration sensor, a gyro sensor, or the like and who is able to measure a position and a movement speed. The reference moving object 220 may be an automatic conveyance vehicle (self-driving vehicle) that moves autonomously. Furthermore, the reference moving object 220 may be a vehicle that is capable of measuring a position and a movement speed and that travels on an expressway or a general road. It is assumed that the position, orientation, and speed to be transmitted by the reference moving object 220 are a position, orientation, and speed in a coordinate system of the movement area (see a coordinate system 438 described below in FIG. 6), and are calibrated in advance.

### <<Input/Output Unit>>

User interface devices such as a display, a keyboard, and a mouse are connected to the input/output unit 180. The input/output unit 180 includes a communication device, and is thus capable of sending and receiving data to and from the camera 210 and the reference moving object 220. In addition, a media drive may be connected to the input/output unit 180 to enable data to be exchanged using a recording medium.

### <<Storage Unit>>

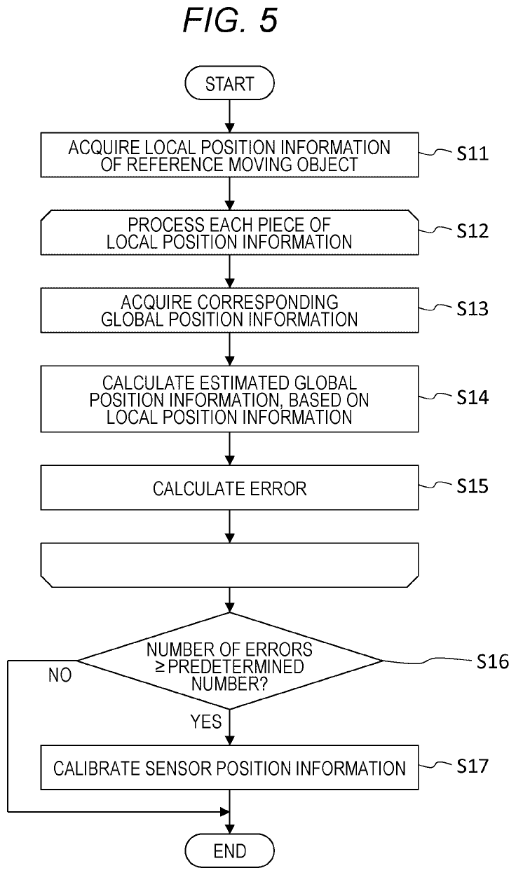

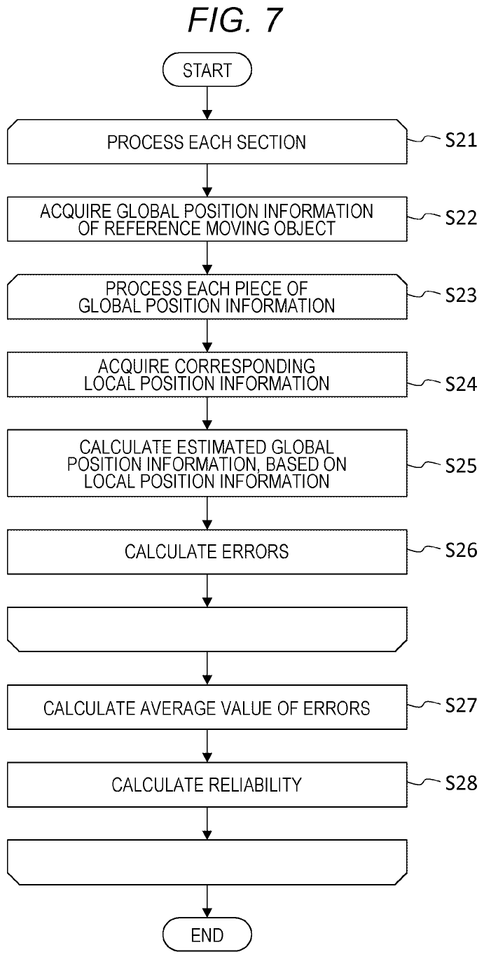

The storage unit 120 includes a storage device such as a ROM (Read Only Memory), a RAM (Random Access Memory, or an SSD (Solid State Drive). The storage unit 120 stores a moving object information database 130, a sensor position information database 140, a measurement information database 150, a reliability map 121, and a program 128. The program 128 includes descriptions of procedures of sensor position calibration processing (see FIG. 5) and reliability map generation processing (see FIG. 7) to be described below. The reliability map 121 will be described below, and the moving object information database 130, the sensor position information database 140, and the measurement information database 150 will be described hereinbelow.

### <<Storage Unit: Moving Object Information Database>>

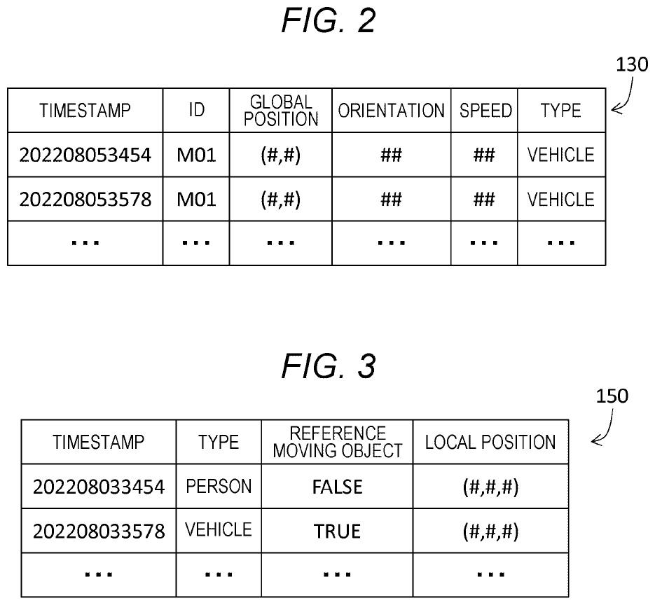

FIG. 2 is a data configuration diagram of the moving object information database 130 according to the first embodiment. The moving object information database 130 is, for example, tabular data, and stores information to be transmitted by the reference moving object 220. A row (record) of the moving object information database 130 includes columns (attributes) for timestamp, identification information, global position, orientation, speed, and type.

The timestamp is a transmission date and time or a reception date and time of the information. The identification information (described as “ID” in FIG. 2) is identification information of the reference moving object 220. The global position (global position information) is the position of the reference moving object 220, and is the position (coordinates) in the coordinate system of the movement area (see the coordinate system 438 illustrated in FIG. 6). The orientation may be the orientation of the reference moving object 220, the orientation in the coordinate system of the movement area, and the movement direction of the reference moving object 220. The speed is the movement speed of the reference moving object 220, and may include the movement direction. The type is the type of the reference moving object 220.

### <<Storage Unit: Sensor Position Information Database>>

The sensor position information database 140 stores parameters such as a focal length, an aspect ratio, and a resolution of the camera 210. The sensor position information database 140 includes information on the position and attitude of the calibrated camera 210. This position and attitude are updated each time sensor position calibration processing (see FIG. 5) to be described below is executed, and accuracy is expected to improve. Note that it is assumed that the position and attitude acquired through calibration using, for example, a marker board at the time of installation of the camera 210 are set as initial the values of the position and the attitude of the camera 210.

### <<Storage Unit: Measurement Information Database>>

FIG. 3 is a data configuration diagram of the measurement information database 150 according to the first embodiment. The measurement information database 150 is, for example, tabular data, and stores position information observed by the camera 210 of the moving object including the reference moving object 220 in the movement area. A row (record) of the measurement information database 150 includes columns (attributes) for timestamp, type, reference moving object, and local position.

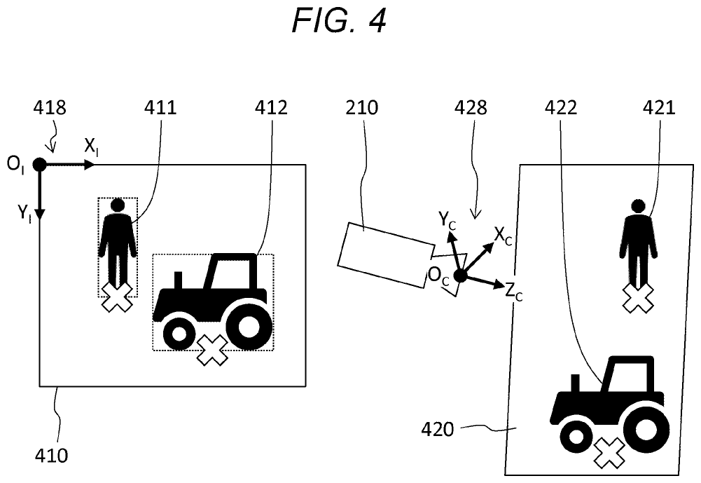

The timestamp is a date and time when the moving object was observed by the camera 210. The type is the type of the moving object observed, such as a vehicle or a person. The reference moving object indicates the correctness (“TRUE” or “FALSE”) of the observed moving object. The local position (local position information) is the position of the observed moving object, and is not the coordinate system of the movement area but the position (coordinates) of the camera 210 in the coordinate system (see coordinate system 428 illustrated in FIGS. 4 and 6 to be described below).

### <<Control Unit>>

Returning to FIG. 1, the control unit 110 will be described. The control unit 110 is configured including a CPU (Central Processing Unit), and includes a moving object information acquisition unit 111, a moving object measurement unit 112, a calibration unit 113, a calibration error calculation unit 114, a reliability map generation unit 115, and a moving object control unit 116. The control unit 110 may be configured using a GPU (Graphics Processing Unit), an FPGA (Field Programmable Gate Array), an ASIC (Application Specific Integrated Circuit), or the like.

### <<Control Unit: Moving Object Information Acquisition Unit>>

The moving object information acquisition unit 111 stores the position (self-position), orientation, and speed of the reference moving object 220 itself transmitted by the reference moving object 220, in the moving object information database 130 (see FIG. 2). Under timestamp, the timestamp given by the reference moving object 220 may be stored without further processing, or the received date and time may be stored.

As described above, the sensor position calibration device 100 includes the moving object information acquisition unit 111 that acquires the self-position measured by the moving object (reference moving object 220) moving in the movement area.

### <<Control Unit: Moving Object Measurement Unit>>

The moving object measurement unit 112 calculates the local position (local position information) of the reference moving object 220 based on captured images (observation information) of the camera 210. The local position is the position of the reference moving object 220 in the coordinate system of the camera 210. Hereinafter, a method in which the moving object measurement unit 112 calculates the local position on the basis of the captured images of the camera 210 will be described.

FIG. 4 is a diagram to illustrate local positions according to the first embodiment. An image 410 is an image of a movement area 420 that includes the moving objects 421, 422 imaged by the camera 210. The moving object 421 is a person, and the moving object 422 is a vehicle, which is the reference moving object 220. An oblique cross immediately below the moving object 422 indicates the position of the moving object 422 in the coordinate system 428 (O_{C}X_{C}Y_{C}Z_{C}) of the camera 210. The same applies to the moving object 421.

Each of the moving objects 411, 412 is a captured image of the moving objects 421, 422 in the movement area 420. The dotted rectangles (detection frames) surrounding the moving objects 411, 412 indicate regions of the moving objects 411, 412 detected from the image 410 by the moving object measurement unit 112, and are called bounding boxes, for example. The moving object measurement unit 112 detects the moving object of the image 410 together with the type thereof and the correctness or incorrectness of the reference moving object 220 by using a technique such as a convolutional neural network or AdaBoost, for example.

The oblique crosses immediately below the detection frames indicate the positions of the moving objects 411, 412 in a coordinate system 418 (O_{I}X_{I}Y_{I}) of the image 410.

The moving object measurement unit 112 converts the positions (x_{I}, y_{I}) of the moving objects 411, 412 in the coordinate system 418 of the image 410 into the coordinate system (x_{C}, y_{C}, z_{C}) of the camera 210 by using the Equations (1) and (2) below.

$$\begin{matrix}[ Equation 1 ] & \\ K = [ \begin{matrix}f & sf & {c}_{X} & 0 \\ 0 & af & {c}_{Y} & 0 \\ 0 & 0 & 1 & 0\end{matrix} ] & ( 1 )\end{matrix}$$

$$[ \begin{matrix}\begin{matrix}{x}_{I} \\ {y}_{I}\end{matrix} \\ 1\end{matrix} ] = K [ \begin{matrix}\begin{matrix}\begin{matrix}{x}_{C} \\ {y}_{C}\end{matrix} \\ {z}_{C}\end{matrix} \\ 1\end{matrix} ] \qquad ( 2 )$$

In Equation (1), f denotes the focal length, a denotes the aspect ratio, s denotes the skew, and (c_{X}, c_{Y}) denotes the coordinates of an image center in the coordinate system 418 of the image 410, which are values stored in the sensor position information database 140 (see FIG. 1). The moving object measurement unit 112 calculates (x_{C}, y_{C}, z_{C}), which satisfies the Equations (1) and (2), on the basis of the coordinates (x_{I}, y_{I}) in the image 410, and stores the calculation results in the measurement information database 150. More specifically, the moving object measurement unit 112 adds a record to the measurement information database 150, stores the date and time of observation as the timestamp, the type of the detected moving object as the type, the correctness or incorrectness of the reference moving object 220 as the reference moving object, and the calculated (x_{C}, y_{C}, z_{C}) as the local position.

As described above, the sensor position calibration device 100 includes the moving object measurement unit 112, which measures the position of the moving object (reference moving object 220) (see the local position of the measurement information database 150 illustrated in FIG. 3) based on the observation information (captured images) of the sensor (camera 210).

### <<Control Unit: Calibration Unit>>

Returning to FIG. 1, the description of the control unit 110 will be continued. The calibration unit 113 calibrates the position information of the camera 210 based on the global position information (see the moving object information database 130 in FIG. 2) and the local position information (see the measurement information database 150 in FIG. 3) of the reference moving object 220.

Hereinafter, processing by the calibration unit 113 will be described with reference to FIGS. 5 and 6.

FIG. 5 is a flowchart of sensor position calibration processing according to the first embodiment. The sensor position calibration processing is processing executed at predetermined timing, for example, periodically.

In step S11, the calibration unit 113 acquires the local position information of the reference moving object 220 and the corresponding timestamp. More specifically, the calibration unit 113 acquires the local position information and the timestamp of a record in which the reference moving object is “TRUE” in the measurement information database 150. The calibration unit 113 may acquire the local location information and the corresponding timestamp in the record in which the timestamp is included in the latest period of a predetermined period length.

In step S12, the calibration unit 113 starts processing to repeat steps S13 to S15 for each piece of local position information acquired in step S11.

Hereinafter, the local position information to be subjected to the repetitive processing is referred to as processing-target local position information.

In step S13, the calibration unit 113 acquires global position information corresponding to the processing-target local position information. More specifically, the calibration unit 113 acquires, in the moving object information database 130, the global position information included in a record for which the difference between the timestamp and the timestamp of the processing-target local position information is equal to or less than a predetermined value and is the smallest. In a case where a record of the moving object information database 130 for which the difference between the timestamps is equal to or less than the predetermined value is not found, the calibration unit 113 stops the repetitive processing on the current processing-target local position information and performs repetitive processing of step S13 and subsequent steps on the next processing-target local position information.

In step S14, the calibration unit 113 calculates estimated global position information (also referred to as the estimated position), based on the local position information. FIG. 6 is a diagram to illustrate a relationship between the local position coordinate system 428 and the global position coordinate system 438 according to the first embodiment. The global position coordinate system 438 (O_{G}X_{G}Y_{G}Z_{G}) is a coordinate system in the movement area 430. The coordinates (x_{C}, y_{C}, z_{C}) of the local position coordinate system 428 and the coordinates (x_{G}, y_{G}, z_{G}) of the global position coordinate system 438 can be transformed using Equations (3) and (4) below. The calibration unit 113 calculates the global position information based on the local position information by using Equations (3) and (4) to obtain the estimated global position information.

$$\begin{matrix}[ Equation 2 ] & \\ R = [ \begin{matrix}{r}_{11} & {r}_{12} & {r}_{13} & {t}_{X} \\ {r}_{21} & {r}_{22} & {r}_{23} & {t}_{Y} \\ {r}_{31} & {r}_{32} & {r}_{33} & {t}_{Z} \\ 0 & 0 & 0 & 1\end{matrix} ] & ( 3 )\end{matrix}$$

$$[ \begin{matrix}\begin{matrix}\begin{matrix}{x}_{C} \\ {y}_{C}\end{matrix} \\ {z}_{C}\end{matrix} \\ 1\end{matrix} ] = R [ \begin{matrix}\begin{matrix}\begin{matrix}{x}_{G} \\ {y}_{G}\end{matrix} \\ {z}_{G}\end{matrix} \\ 1\end{matrix} ] \qquad ( 4 )$$

Here, r₁₁ to r₃₃ in Equation (3) are elements of a rotation matrix calculated from the attitude of the camera 210, and are determined using three parameters, namely, pan θ, tilt φ, and roll ψ, which are installation angles of the camera 210. These values are stored in the sensor position information database 140.

(t_{X}, t_{Y}, t_{Z}) are the coordinates of an origin O_{C} of the camera 210 in the global position coordinate system 438. Note that a position in the movement area 430 is represented as two-dimensional coordinates on the road surface of the movement area 430, and is calculated as z_{G}=0.

In step S15, the calibration unit 113 calculates an error (distance) between the global position information acquired in step S13 and the estimated global position information calculated in step S14.

In step S16, if the number of errors (the calculated frequency) calculated in step S15 is equal to or greater than a predetermined number (step S16—YES), the calibration unit 113 advances to step S17. If the number of errors is less than the predetermined number (step S16—NO), the calibration unit 113 ends the sensor position calibration processing. In this case, the number of pieces of corresponding local position information and global position information is small, and calibration of the position information of the camera 210 is not performed.

In step S17, the calibration unit 113 calibrates the position and attitude of the camera 210 by using the global position information and the estimated global position information. As a calibration method, a general method is used in which each parameter of the initial position and attitude is varied within a predetermined search range by using bundle adjustment or the like to search for a parameter value that minimizes the total of the errors (see step S15) between the global position information and the estimated global position information. Other methods may be used. The calibration unit 113 stores and updates the calibrated position and attitude of the camera 210 in the sensor position information database 140.

As described above, the sensor position calibration device 100 includes the calibration unit 113 (see step S17 in FIG. 5) that calibrates the position information of the sensor using a self-position (see the global position in the moving object information database 130 in FIG. 2) of the moving object (reference moving object 220), a measured position (see the local position in the measurement information database 150 in FIG. 3), which is the measured position of the moving object, and an estimated position (estimated global position), which is the position of the moving object in the movement area calculated based on the position information (see the sensor position information database 140) of the sensor (camera 210).

<<Control unit: Calibration Error Calculation Unit, Reliability Map Generation Unit>>

Returning to FIG. 1, the description of the control unit 110 will be continued. Similarly to the calibration unit 113, the calibration error calculation unit 114 calculates an error between the estimated global position information calculated based on the local position information, and the global position information. Note that the calibration error calculation unit 114 uses calibrated sensor position information in calculating the estimated global position information.

Based on the error calculated by the calibration error calculation unit 114, the reliability map generation unit 115 generates a reliability map 121 (see FIG. 9 to be described below) indicating the reliability for each zone delimiting the movement area.

FIG. 7 is a flowchart of reliability map generation processing according to the first embodiment. The reliability map generation processing is executed at a predetermined timing, for example, after the sensor position calibration processing.

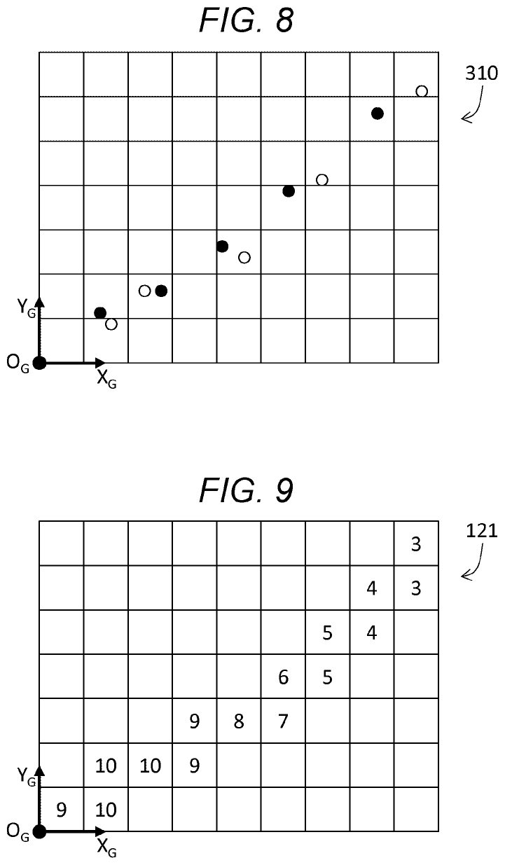

In step S21, the reliability map generation unit 115 starts processing to repeat steps S22 to S28 for each zone delimiting the movement area. FIG. 8 is a diagram showing a movement area 310 divided into zones according to the first embodiment. In FIG. 8, the movement area 310 is divided into a total of 63 zones of 9 zones in the horizontal direction (X-axis direction) and 7 zones in the vertical direction (Y-axis direction). Hereinafter, a zone to be repeatedly processed is referred to as a processing target zone.

Returning to FIG. 7, the description of the reliability map generation processing will be continued.

In step S22, the calibration error calculation unit 114 acquires the global position information and the corresponding time stamp of the reference moving object 220 of which the global position information is in the processing target zone. More specifically, the calibration error calculation unit 114 acquires the global position information and the time stamp of the record, in the moving object information database 130 (see FIG. 2), in which the global position information is in the processing target.

In step S23, the calibration error calculation unit 114 starts processing to repeat steps S24 to S26 for each piece of the global position information acquired in step S22. Hereinafter, the global position information to be subjected to the repetitive processing is referred to as processing-target global position information.

In step S24, the calibration error calculation unit 114 acquires local position information corresponding to the processing-target global position information. More specifically, the calibration error calculation unit 114 acquires local position information included in a record, in the measurement information database 150 (see FIG. 3), for which the difference between the time stamp and the time stamp of the processing-target global position information is equal to or less than a predetermined value and is minimum and in which the reference moving object is “TRUE”. In a case where a record of the measurement information database 150 for which the difference between the timestamps is equal to or less than the predetermined value is not found, the calibration error calculation unit 114 stops the repetitive processing on the current processing-target global position information and performs repetitive processing of step S24 and subsequent steps on the next processing-target global position information.

In step S25, the calibration error calculation unit 114 calculates the estimated global position information based on the local position information by using Equations (3) and (4). Note that the calibration error calculation unit 114 calculates the estimated global position information (also referred to as the second estimated position) by using the latest calibrated sensor position information stored in the sensor position information database 140.

In step S26, the calibration error calculation unit 114 calculates the error (distance) between the processing-target global position information and the estimated global position information calculated in step S25.

In FIG. 8, a black circle denotes a position indicated by the global position information, and a white circle denotes a position indicated by the estimated global position information. The distance between the corresponding black circle and white circle constitutes the error. Note that a black circle and a white circle which are the closest distance from one another correspond to each other. As illustrated in FIG. 8, a position indicated by the corresponding global position information and a position indicated by the estimated global position information are not necessarily in the same zone.

Returning to FIG. 7, the description of the reliability map generation processing will be continued. In step S27, the reliability map generation unit 115 calculates the average value of the errors calculated in step S26. If there is an error outlier, the reliability map generation unit 115 may calculate the average value excluding the outlier. In addition, the reliability map generation unit 115 may calculate the weighted average value by assigning a greater weighting as the difference between the time stamp of the global position information and the time stamp of the local position information becomes smaller.

In step S28, the reliability map generation unit 115 calculates the reliability on the basis of the average value of the errors calculated in step S27, and sets the calculated reliability as the reliability of the processing target zone. The reliability map generation unit 115 calculates the reliability such that the smaller the average value of the errors, the higher the reliability. In step S22, the reliability map generation unit 115 sets the reliability of a zone having no global position information to 0.

Although not illustrated in FIG. 8, the movement speed of the reference moving object 220 is associated with the global position information in addition to the time stamp (see FIG. 2), and the reliability map generation unit 115 is capable of grasping the movement route of the reference moving object 220. The reliability map generation unit 115 calculates the reliability of a zone for which there is no global position information but which constitutes the movement route of the reference moving object 220 by interpolating the reliability calculated based on the average value of the errors on the movement route.

FIG. 9 is a diagram showing the reliability map 121 according to the first embodiment. The numerical values in the zones indicate the reliability. The reliability of a blank zone is 0.

As described above, the sensor position calibration device 100 includes the calibration error calculation unit 114, which calculates an error (see step S26) between the second estimated position (the estimated global position calculated in step S25 in FIG. 7), which is the position of the moving object (reference moving object 220) in the movement area calculated based on the measured position (local position) and the calibrated position information (see the sensor position information database 140) of the sensor (camera 210), and the self-position (global position).

The sensor position calibration device 100 includes a reliability map generation unit 115 that, based on the error, generates a reliability map 121 indicating the reliability of position measurement in the movement area using the sensor.

The reliability map 121 indicates reliability of each of a plurality of zones obtained by dividing the movement area (see FIG. 9), and the smaller the error between the self-position of the moving object in the zone and the second estimated position, the higher the reliability of the zone (see step S28).

<<Reliability Correction Coefficient: Distance from Camera>>

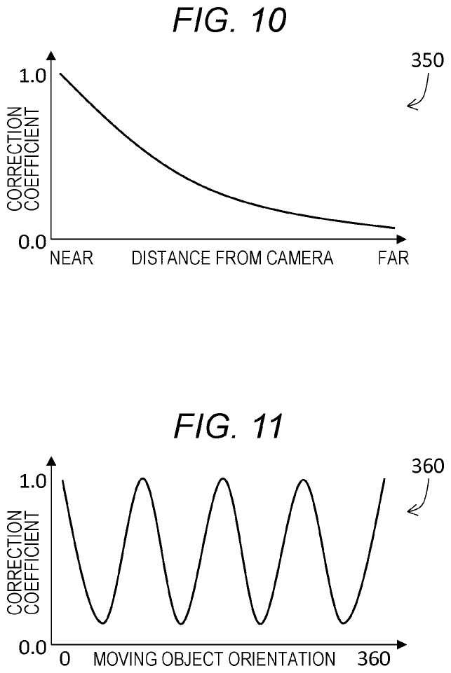

The reliability map generation unit 115 may obtain the reliability by multiplying the reliability calculated based on the average value of the errors by a correction coefficient. An example of the correction coefficient will be described below. FIG. 10 is a graph 350 showing correction coefficients corresponding to distances from a camera 210 to a zone according to the first embodiment. In general, in a case where an object is detected from a captured image of the camera 210 and a local position is measured (see FIG. 4), the farther away the object is, the larger the deviation of the detection frame, and the greater the measurement error. Therefore, as illustrated in the graph 350, the correction coefficient may be made smaller as the distance from the camera 210 increases, and the reliability map generation unit 115 may calculate the reliability to be low.

### <<Reliability Correction Coefficient: Orientation of Reference Moving Object>>

FIG. 11 is a graph 360 showing correction coefficients according to the orientation of the moving object with respect to the camera 210 according to the first embodiment. In a case where the reference moving object 220 is a large object such as a vehicle, if a front surface, a rear surface, or a lateral surface of the vehicle is oriented facing the camera 210, the accuracy of the detection frame is considered to be high and the measurement accuracy of the local position is considered to be stable. However, in a case where the reference moving object 220 is oriented obliquely with respect to the camera 210, there is a concern that the deviation between the local position (the position at the center of the lower end of the detection frame) and the position of the reference moving object 220 will become large, and that there will be a drop in the local position measurement accuracy. For this reason, the reliability map generation unit 115 may calculate the orientation with respect to the camera 210 on the basis of the global position and orientation of the reference moving object 220 (see the orientation in the moving object information database 130 illustrated in FIG. 2), and in a case where a front surface (0 degree), a lateral surface (90 degrees or 270 degrees), or a rear surface (180 degrees) of the reference moving object 220 does not lie directly opposite the camera, the correction coefficient may be reduced, and the reliability map generation unit 115 may calculate the reliability to be low.

### <<Reliability Correction Coefficient: Speed of Reference Moving Object>>

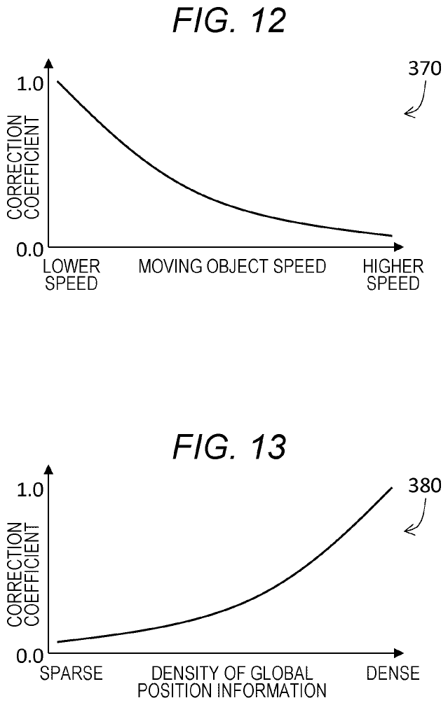

FIG. 12 is a graph 370 showing correction coefficients corresponding to the speed of the moving object according to the first embodiment. In the first embodiment, the global position information and the local position information are associated using the time stamp (see steps S13 and S24 in FIGS. 5 and 7), and a synchronization shift in the position information acquisition timing is a concern. In a case where the reference moving object 220 moves fast, there is a high probability of a deviation occurring between the global position information and the estimated global position based on the local position information. Therefore, as illustrated in the graph 370, the correction coefficient may be made smaller as the movement speed of the reference moving object increases, and the reliability map generation unit 115 may calculate the reliability to be low.

### <<Reliability Correction Coefficient: Sparseness/Denseness of Global Position>>

FIG. 13 is a graph 380 showing correction coefficients corresponding to the sparseness/denseness of a moving object according to the first embodiment. For a zone where a large amount of global position information has been acquired (sparseness/denseness is high), the calibration error is expected to be small. For this reason, as illustrated in the graph 380, the lower the sparseness/denseness of the global position information of the reference moving object 220, the smaller the correction coefficient, and the reliability map generation unit 115 may calculate the reliability to be low. Note that the sparseness/denseness of a zone is calculated by dividing the number of records, in the moving object information database 130, for which the global position information is the zone, by the surface area of the zone. If the surface areas of the zones are equal, the sparseness/denseness of the zones may be the number of records for which the global position information is the zone.

### <<Other Reliability Corrections>>

If there is a road surface gradient, there is a concern that there will be a drop in the measurement accuracy of the local position information by using the detection frame of the reference moving object 220.

Therefore, the correction coefficient may be made smaller as the road surface gradient of the zone increases, and the reliability map generation unit 115 may calculate the reliability to be low.

When many moving objects including the reference moving object 220 moving in the zone are congested at the time the local position information is acquired, there is a concern that there will be a drop in the measurement accuracy of the local position information by using the detection frame of the reference moving object 220. For this reason, the number of records for which there is a small difference between the time stamp and the local position is larger for the reference moving object 220 included in the measurement information database 150 (see FIG. 3), and the higher the degree of congestion, the smaller the correction coefficient, and the reliability map generation unit 115 may calculate the reliability to be low.

As described above, the reliability map generation unit 115 corrects the reliability by using at least one of the distance between the sensor (camera 210) and the moving object (reference moving object 220) (see FIG. 10), the orientation of the moving object with respect to the sensor (see FIG. 11), the speed of the moving object (see FIG. 12), the sparseness/denseness of the self-position of the moving object (see FIG. 13), the degree of congestion of other moving objects around the moving object, and the gradient of the road surface.

### <<Control Unit: Moving Object Control Unit>>

Returning to FIG. 1, the description of the control unit 110 will be continued. The moving object control unit 116 controls the movement route of the reference moving object 220 based on the reliability map 121. More specifically, the moving object control unit 116 controls the reference moving object 220 so as to pass through a zone of low reliability. Furthermore, the moving object control unit 116 may cause the reference moving object 220 to move at a low speed in a zone of low reliability, to move when another moving object is not in the zone, or to move with a front surface, a lateral surface, or a rear surface thereof oriented toward the camera 210. The moving object control unit 116 may perform control such that the reference moving object 220 does not move at a low speed but temporarily stops in the zone.

As a result of the moving object control unit 116 controlling the reference moving object 220, it is to be expected that the local position observation accuracy in a zone of low reliability will improve, that the error between the global position and the estimated global position will be smaller, thereby improving the reliability.

As described above, the sensor position calibration device 100 includes the moving object control unit 116 that controls the movement of the moving object (reference moving object 220) by using the reliability map 121.

The moving object control unit 116 controls the movement of the moving object so that same travels in a zone of lower reliability.

When the moving object is to travel in a zone of low reliability, the moving object control unit 116 controls movement of the moving object so as to satisfy at least one of: traveling at a low speed, and traveling with the front surface, lateral surface, or rear surface of the moving object oriented toward the sensor (camera 210).

### <<Characteristics of Sensor Position Calibration Device>>

The sensor position calibration device 100 calibrates the position information of the camera 210 based on the global position information transmitted by the reference moving object 220 and the estimated global position calculated based on the local position information acquired by the camera 210 (see step S17 illustrated in FIG. 5). Further, the sensor position calibration device 100 generates the reliability map 121 (see FIG. 9) based on an error between the global position information and the estimated global position information. The sensor position calibration device 100 refers to the reliability map 121 and controls the reference moving object 220 such that the reference moving object 220 moves at a low speed in a zone of low reliability, or with a front surface, a lateral surface, or a rear surface thereof oriented toward the camera 210. Accordingly, the sensor position calibration device 100 is capable of performing calibration of the position information of the camera 210 highly accurately over the entire movement area. As described above, the sensor position calibration device 100 performs efficient vehicle control for highly accurate calibration according to the accuracy of sensor position calibration (zone reliability).

### <<Modification: Reference Moving Object>>

In the above-described embodiments, the reference moving object 220 is a vehicle, but the present invention is not limited thereto. The reference moving object 220 may be a person holding a terminal (for example, a smartphone) including a GNSS, an acceleration sensor, a gyro sensor, and the like who is thus able to measure a position and a movement speed. The sensor position calibration device 100 may control movement by instructing the person to move via the terminal. Where reliability is concerned in a case where a person is used as the reference moving object 220, unlike a vehicle, the person is small, and the difference in accuracy of the local position based on orientation is considered to be small, and hence orientation-based correction with respect to the camera 210 (see FIG. 11) may not be performed.

In the above-described embodiments, the reference moving object 220 is distinguished from other moving objects (see the reference moving object of the measurement information database 150 illustrated in FIG. 3), but the reference moving object need not be distinguished. If the accuracy of the position information of the camera 210 set as the initial value is high, or the accuracy of the position information is increased by repeating the calibration, it is to be expected that the deviation between the global position information and the estimated global position information will be small. Accordingly, the local position information of all the observed moving objects may be converted into the estimated global position information, the distance between same and the global position information of the reference moving object 220 may be compared, and the moving object having the closest local position information may be determined as the reference moving object 220. In addition, there may be a plurality of reference moving objects 220, and calibration can be executed at high speed.

### Second Embodiment

The moving object control unit 116 according to the first embodiment described above controls the movement of the reference moving object 220 so as to improve the reliability of a zone of low reliability. In the second embodiment, the reliability map 121 is used for purposes other than calibration.

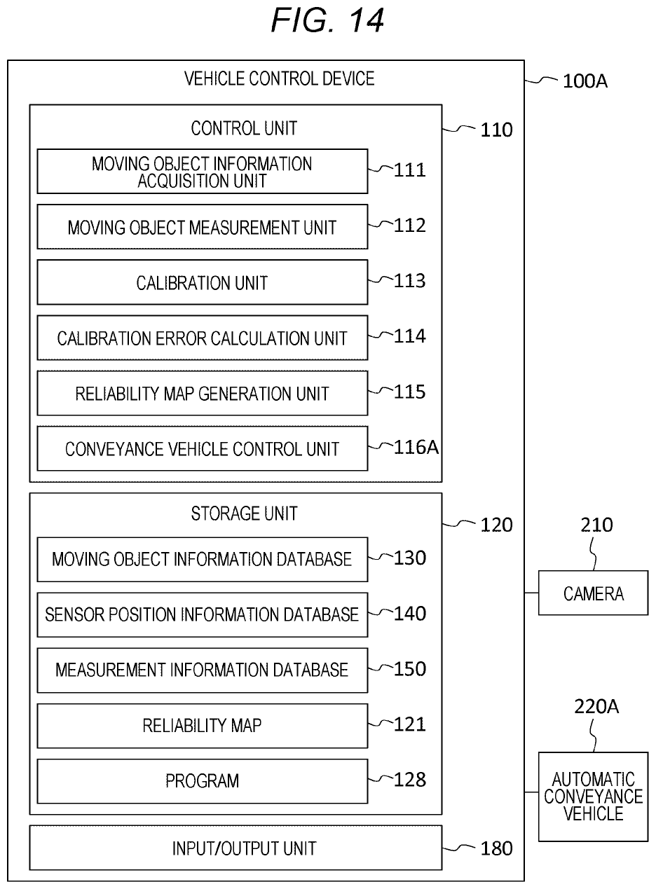

FIG. 14 is a functional block diagram of a vehicle control device 100A (sensor position calibration device) according to a second embodiment. The reference moving object to be controlled by the vehicle control device 100A is an automatic conveyance vehicle 220A that transports a load including a person. In comparison with the sensor position calibration device 100 according to the first embodiment, the control unit 110 of the vehicle control device 100A includes a conveyance vehicle control unit 116A instead of the moving object control unit 116.

In a case where the automatic conveyance vehicle 220A is to perform conveyance, the conveyance vehicle control unit 116A refers to the reliability map 121 to generate a conveyance route of the automatic conveyance vehicle 220A, and controls the automatic conveyance vehicle 220A to travel along the conveyance route. For example, the conveyance vehicle control unit 116A generates a conveyance route of the shortest distance passing through zones having a reliability equal to or greater than a predetermined value, or generates a conveyance route of the shortest time by setting an upper limit for the speed according to the reliability. Note that the higher the reliability of a zone, the higher the upper limit for the speed in the zone. When generating the conveyance route, the conveyance vehicle control unit 116A may consider not only the reliability of the zones through which the automatic conveyance vehicle 220A is to pass but also the reliability of the zones adjacent to these zones.

A target to be controlled by the conveyance vehicle control unit 116A may also be a person. In order to ensure the safety of a person moving in the movement area, the conveyance vehicle control unit 116A may generate a movement route passing through zones of a reliability equal to or higher than a predetermined value, notify the person, and guide the person to pass along the movement route.

In a case where there is a plurality of automatic conveyance vehicles 220A and respective conveyance routes are to be generated, the conveyance vehicle control unit 116A may generate the conveyance routes so that the distance between the automatic conveyance vehicles 220A is equal to or greater than a predetermined distance corresponding to the reliability of the zone. Note that the higher the reliability of a zone, the shorter the predetermined distance in the zone.

The conveyance vehicle control unit 116A may monitor the measurement information database 150 (see FIG. 3), and in a case where a moving object is present within a predetermined distance of the automatic conveyance vehicle 220A during automatic conveyance, may notify the automatic conveyance vehicle 220A of that fact including the reliability, or may perform control to reduce the speed thereof. Note that the higher the reliability of a zone, the shorter the predetermined distance.

As described hereinabove, in a case where the moving object is a person or when the moving object (automatic conveyance vehicle 116A) is to perform conveyance, the moving object control unit (conveyance vehicle control unit 220A) controls the movement of the moving object (reference moving object 220) so that same travels in zones of higher reliability.

The moving object control unit controls the movement of the moving object such that an upper limit for the speed of the moving object is high in a zone of high reliability and is low in a zone of low reliability.

### <<Characteristics of Second Embodiment>>

By performing the control described above, the vehicle control device 100A is capable of performing efficient automatic conveyance. More specifically, the risk of an accident including contact between the automatic conveyance vehicle 220A and a moving object can be reduced by using the camera 210 to detect the moving objects around the automatic conveyance vehicle 220A. By considering the reliability of the reliability map 121 as the reliability or accuracy of detection, the risk can be reduced in a zone of low reliability by reducing the speed or securing an interval from a moving object. In addition, in a zone of high reliability, efficient automatic conveyance can be performed without a reduction in speed or securing an interval from a moving object. Note that, although automatic conveyance has been described as an example, the present invention is not limited thereto, and similar control of a moving object may be performed even in the case of movement such as patrol. As described above, the vehicle control device 100A performs efficient vehicle control for automatic conveyance in accordance with the accuracy of sensor position calibration (zone reliability).

### <<Modification: Moving Object Control for Calibration>>

In a case where there is no cargo to be conveyed and the automatic conveyance vehicle 220A is vacant, the conveyance vehicle control unit 116A may perform control such that the automatic conveyance vehicle 220A moves at a low speed in a zone of low reliability or with a front surface, a lateral surface, or a rear surface thereof oriented toward the camera 210, as per the first embodiment. Furthermore, in a case where the restriction of the conveyance time is small even for the automatic conveyance vehicle 220A during automatic conveyance, the automatic conveyance vehicle 220A may be controlled to move at a low speed in a zone of low reliability or with a front surface, a lateral surface, or a rear surface thereof oriented toward the camera 210.

The conveyance vehicle control unit 116A may control the automatic conveyance vehicle 220A on the basis of a rule which corresponds to reliability other than that described above.

### <<Other Modifications>>

The conveyance vehicle control unit 116A may output a map indicating the conveyance route and the reliability of the zone through which the conveyance route passes to a display device connected to the input/output unit 180 ask an operator (administrator) of the automatic conveyance vehicle 220A whether automatic conveyance is possible. In addition, the conveyance vehicle control unit 116A may output the reliability map 121 to the display device to inquire whether or not it is correct to continue (repeatedly execute) the sensor position calibration processing (see FIG. 5) or continue the control so that the automatic conveyance vehicle 220A moves in a zone of low reliability.

A moving object traveling in the movement area according to the second embodiment described above is the automatic conveyance vehicle 220A, which is a reference moving object, and transmits an own position, orientation, and speed to the vehicle control device 100A. The moving object traveling in the movement area may not be the reference moving object, and may be a moving object that does not transmit an own position, orientation, and speed to the vehicle control device 100A. In a case where another moving object is present within a predetermined distance corresponding to the reliability of the zone being traveled in, the vehicle control device 100A may notify the moving object traveling in the movement area of this fact together with the reliability. Furthermore, the vehicle control device 100A may also control movement by generating the movement route of the moving object based on zone reliability.

Although some embodiments of the present invention have been described hereinabove, these embodiments are merely examples and do not limit the technical scope of the present invention. The present invention may adopt various other embodiments, and various modifications such as omissions and substitutions can be made without departing from the spirit of the present invention. Such embodiments and modifications thereof are included in the scope and spirit of the invention described in the present specification and so forth, and are incorporated into the invention set forth in the claims and the equivalent scope thereof.

What is claimed is:

1. A sensor position calibration device, comprising:
a moving object information acquisition unit that acquires a self-position measured by a moving object moving in a movement area;
a moving object measurement unit that measures a position of the moving object based on observation information of a sensor;
a calibration unit that calibrates position information of the sensor by using the self-position of the moving object and an estimated position, which is a position of the moving object in the movement area calculated based on a measured position and the position information of the sensor, the measured position being a position of the moving object measured;
a calibration error calculation unit that calculates an error between a second estimated position and the self-position, the second estimated position being a position of the moving object in the movement area calculated based on the measured position and the calibrated position information of the sensor;
a reliability map generation unit that, based on the error, generates a reliability map indicating reliability of position measurement in the movement area using the sensor; and
a moving object control unit that controls movement of the moving object by using the reliability map.

2. The sensor position calibration device according to claim 1, wherein
the reliability map indicates reliability of each of a plurality of zones obtained by dividing the movement area, and
the smaller the error between the self-position of the moving object in a zone among the zones and the second estimated position, the higher the reliability of the zone.

3. The sensor position calibration device according to claim 2, wherein the reliability map generation unit corrects the reliability by using at least one of a distance between the sensor and the moving object, an orientation of the moving object with respect to the sensor, a speed of the moving object, sparseness/denseness of the self-position of the moving object, degree of congestion of other moving objects around the moving object, and a gradient of a road surface.

4. The sensor position calibration device according to claim 2, wherein the moving object control unit controls the movement of the moving object so that the moving object travels in a zone where the reliability is lower.

5. The sensor position calibration device according to claim 4, wherein, when the vehicle is to travel in a zone where the reliability is low, the moving object control unit controls the movement of the moving object so as to satisfy at least one of: traveling at a low speed; and traveling with a front surface, a lateral surface, or a rear surface of the moving object oriented toward the sensor.

6. The sensor position calibration device according to claim 2, wherein, in a case where the moving object is a person or in a case where the moving object is to perform conveyance, the moving object control unit controls the movement of the moving object so that the moving object travels in a zone where the reliability is higher.

7. The sensor position calibration device according to claim 6, wherein the moving object control unit controls the movement of the moving object such that an upper limit for a speed of the moving object is high in a zone where the reliability is high and is low in a zone where the reliability is low.

8. A sensor position calibration method executed by a sensor position calibration device, the method comprising:
acquiring a self-position measured by a moving object moving in a movement area;
measuring a position of the moving object based on observation information of a sensor;
calibrating position information of the sensor by using the self-position of the moving object and an estimated position, which is a position of the moving object in the movement area calculated based on a measured position and the position information of the sensor, the measured position being a position of the moving object measured;
calculating an error between a second estimated position and the self-position, the second estimated position being a position of the moving object in the movement area calculated based on the measured position and the calibrated position information of the sensor;
generating, based on the error, a reliability map indicating reliability of position measurement in the movement area using the sensor; and
controlling movement of the moving object by using the reliability map.
